(19) United States
(12) Patent Application Publication
(10) Pub. No.: US 2023/0135004 A1
(43) Pub. Date: May 4, 2023

(54) POLYMER NANOCOMPOSITE FOR USE IN ELECTRICAL AND ELECTRONIC EQUIPMENT WITH PROPERTIES SUITABLE FOR APPLICATIONS SUCH AS ELECTRICAL INSULATION AND WITH THERMAL CONDUCTIVITY GAIN

(71) Applicants: Fundação Universidade Federal De São Carlos, Sao Carlos (BR); Petróleo Brasileiro S.A. - Petrobras, Rio de Janeiro (BR)

(72) Inventors: Rafael Barbosa, Araraquara (BR); José Donato Ambrósio, Sao Carlos (BR); Lidiane Cristina Costa, Sao Carlos (BR); Claudemiro Bolfarini, Sao Carlos (BR); Guilherme Eduardo De Oliveira Blanco, Sao Carlos (BR); Alexander Hiroshi Kasama, Petropolis (BR); Ana Margarida De Oliveira, Niteroi (BR); Diego Alexandre Belmonte Barbosa, Rio de Janeiro (BR); Rafael De Almeida Peçanha, Niteroi (BR)

(21) Appl. No.: 17/976,117

(22) Filed: Oct. 28, 2022

(30) Foreign Application Priority Data
Oct. 29, 2021 (BR) 10 2021 021770 7

(51) Int. Cl. C08K 13/02

(52) U.S. Cl. CPC C08K 13/02

(57) ABSTRACT

The present invention belongs to the field of chemistry, more specifically to the field of polymers. The present invention relates to a polymer nanocomposite for use in electrical and electronic equipment with properties suitable for applications such as electrical insulating and with thermal conductivity gain. The nanocomposite comprises at least one polymer matrix, at least one inorganic filler, at least one carbonaceous filler and at least one additive.

### FIELD OF THE INVENTION

In a comprehensive way, the present invention is included in the consumer goods sector that demand some transmission of electric power which must be isolated from other components, that is, the material can be applied in any electrical and/or electronic device. More specifically, it refers to polymer nanocomposites for use in electrical and electronic equipment with properties suitable for applications such as electrical insulation and with thermal conductivity gain. Additionally, it refers to the process of obtaining said polymer nanocomposites, whose main differential is the fact that they are electrical insulating and, at the same time, heat sinks.

### DESCRIPTION OF THE STATE OF THE ART

Polymers, in general, are materials that have a high electrical insulation capacity, which is based on their morphological structure less organized than that of conductive materials, such as metals. However, their use as an electrical insulating is hampered by their relatively low thermal stability, also a characteristic of most polymers, which leads to insulation failure due to local temperature rise. Focusing on this application and thermal limitation, certain improvements were made, wherein polymers are currently used in many applications as electrical insulating.

In the 1950s, Ziegler and Natta discovered that they could polymerize alkenes (carbon-carbon double bonds) with catalysts they had developed. The next development was the use of dicumyl peroxide to link polyethylene or ethylene-propylene chains. These crosslinking, or curing, bonds were thermally more stable than the crosslinks induced by the reaction called sulfur vulcanization, which was used until so. This also allowed saturated polymer chains, such as low density polyethylene (LDPE), to be crosslinked effectively, forming crosslinked polyethylene (XLPE). Since the mid-20th century, most electrical cables in the 5 to 69 kV range were insulated with XLPE or some ethylene-propylene (EP) copolymer.

The growing demand for energy for different electrical equipment, and the miniaturization of electronic devices have created new challenges concerning the materials used as electrical insulating and protective coatings for electro-electronics. A strategical technical point for the future will be the use of electrical insulating materials that have higher thermal conductivities for heat dissipation. The higher the heat dissipation, the lower the maximum temperature of the insulation under steady or transient operation. The thermal conductivity of polymers is generally in the range of 0.1-0.5 Wm⁻¹K⁻¹. In this sense, the main objectives are to develop materials with high thermal conductivity, low coefficient of thermal expansion (CTE), low dielectric constant, high electrical resistivity and high mechanical resistance.

The thermal conductivity of the materials is obtained by the heat flow carried through the solid. Heat flow is expressed as the heat flowing per unit time through a unit cross-section. This property is directly related to the chemical structure and crystallographic structure (in the case of polymers, amorphous and crystalline microstructure) of the material. The type of chemical bonding made by the atoms defines which types of heat carriers are available for conduction, phonons and/or electrons, and photons and other less influential types can also transport heat. In metallic materials, thermal conductivity is generally higher than in ionic and covalent materials, due to the abundance of free electrons that can transport heat at higher speeds and with less hindrance, making the phonon transport less significant. In materials with ionic and covalent bonds, electrons do not have such mobility and so heat is transmitted mainly by phonons, which are quantized vibrations of the atomic or molecular lattice. Even though phonons move at the speed of sound, many collisions with other phonons or lattice defects occur in their path, which decreases thermal conductivity. In polymers, the mechanisms of phonon heat transport are due to molecular rotation, vibration and translation, and the semicrystalline or amorphous molecular lattice has a more disordered orientation or imperceptible organization. Thus, there is an intense decay in the mean free path, due to the scattering of phonons between molecules and between polymeric chains. This fact makes the phonon transport not effective and, when added to the lack of free electrons in the polymers, it confers them a low thermal conductivity, being classified as insulatings.

In an attempt to overcome this deficiency, studies have been carried out on polymer matrix nanocomposites with mineral fillers of high thermal conductivity, that is, with better phonon and/or electron transport capacity. The justification of these studies is the formation of preferential thermally conductive paths formed by these mineral fillers, transporting heat from one surface to another of the insulating matrix. The high thermal conductivity of the fillers influences the total transfer of the nanocomposite, and the reduction of their size to the nanometric scale facilitates the formation of a percolated network with low volume filler concentrations.

The incorporation of heat conductors such as metallic oxides and ceramic materials in the polymers can effectively improve the thermal conductivity of the polymer matrix of electrical and electronic devices. Fillers with high thermal conductivity, such as aluminum oxide (Al₂O₃), aluminum nitride (AlN), boron nitride (BN), silicon nitride (Si₃N₄), beryllium oxide (BeO), silicon carbide (SiC) or diamond, are promising in the production of electrical insulating and thermally conductive nanocomposites. Carbonaceous fillers such as graphite, carbon black, carbon nanotubes (CNT), graphene, graphene oxide, among others, are also evaluated as for the use in thermally conductive nanocomposites, given their high thermal conductivities. However, this last class of materials are also good electrical conductors, which can impair their application in insulatings.

Boron nitride (BN) is a filler that has been applied into polymeric matrices and has shown good results in increasing thermal conductivity, without jeopardizing the electrical insulating character of the matrix. It occurs mainly in its hexagonal form, the so-called hexagonal boron nitride (h-BN). Recently, BN nanotubes and nanosheets (nanoplates) have also attracted significant research interest. BN nanotubes and nanosheets have advantages over conventional BN due to their high aspect ratio and high surface area, being promising fillers for high thermal conductivity composites.

It is intended, upon the addition of fillers, to produce thermally conductive paths in the bulk (internal volume of the material), facilitating the heat transfer. In this case, the polymer-filler and filler-filler interfaces can be optimized, aiming to reduce the interfacial tension, the thermal contact resistance and increased adhesion. To this end, surface treatments of compatibility can also be carried out on the conductive fliers, given the chemical difference between inorganic fillers and the organic polymer matrix. h-BN, for example, is an inorganic material that requires good interfacial adhesion to transfer its properties to a certain organic polymer matrix. This process is usually achieved through the functionalization of h-BN. Functionalization is the process of introducing reactive functional groups onto the surface of the material, which can react with other functional groups of other materials through chemical or physical (Van der Waals) bonds.

Functionalization can be divided into two main types: covalent or non-covalent. Covalent functionalization is usually carried out by compounds that aim to incorporate reactive nitrogenous or oxygenated radicals. For thermal conductivity, for example, the connection between filler and matrix by covalent bonds is more beneficial for the transmission of the property, since intramolecular phonon heat conduction is more efficiently. In non-covalent functionalization, there is the insertion of hydroxyls onto the surface, which can perform secondary intermolecular bonds between the filler and the polymer matrix. In this case, intermolecular bonds are much less efficient in conducting heat.

The proposed invention was carried out with the intention of obtaining an improvement in the thermal conductivity of polymer nanocomposites from the introduction of inorganic thermally conductive and electrically insulative fillers and additionally of carbon-based conductive fillers that conduct both thermal energy and electric power. This aspect is based on some researches that use a second conductive filler (hybridization) having the function of helping the percolation of a thermal conductivity network, but in small concentrations that prevent the percolation of an electrically conductive network, which would harm the dielectric properties. Hybridization is based on the use of fillers from different materials, which can also have or not different sizes, shapes and aspect ratios. In this invention, it is contemplated the use of micrometric hexagonal boron nitride, which has the shape of plates and relatively low aspect ratio, together with nanometric carbon nanotubes, which have the shape of elongated tubes and very high aspect ratio. The union of these materials resulted in a synergy in terms of increased thermal conductivity.

Document CN108659537 uses an organic silicon as a matrix. In the proposed invention, the matrix is a crosslinked polyolefin. The method of preparation and formulation also are different. The thermal conductivity reached by the proposed invention (0.573 W/(mK)) is also greater than that of the patent (0.247-0.410 W/(mK)), which represents a progress despite the applications being also different.

Document WO2013115925 refers to two types of compounds: a fluid and an elastomeric. The fluid one is quite different from the proposed invention, which is a solid polymer nanocomposite. The elastomeric compound differs in the type of polymer and the types of additives used, such as not using carbonaceous fillers. In the proposed invention, hybrid fillers (boron nitride and carbon nanotubes) are used, achieving good thermal conductivity with lower filler concentrations. In the patent, only boron nitride is used. The polymers used are different, the proposed invention being based on polyolefins and this patent based on fluoroelastomers. The polymer intersection is only in the use of EPDM in both inventions. Polyolefins are lower cost materials than fluoroelastomers, being applied more frequently in different situations.

Document JP2019172937 deals with a composition used for radiating heat in electronic devices. It differs from the proposed invention by using polyesters as the matrix polymer and by using three different types of inorganic thermally conductive fillers. Furthermore, the third filler used is diamond, which is expensive compared to the fillers of the proposed invention.

Document KR1831595 discloses a composite produced with flame retardant additives, such as hydroxyl and phosphorus-based components, different from the proposed invention. It also has other additives, such as processing oils, which are not found in the formulation of the invention. Furthermore, in the patent the polymer matrix is composed of thermoplastic elastomers (TPE) with the possible addition of rubbers, which differs from the proposed invention, which uses polyolefins.

Document JP2017016862 discloses an electrical wire insulation containing an electrically insulating and thermally conductive layer. This layer is composed of polyimide-type resins, different from the polyolefins that are used in the proposed invention. The processing and resulting properties of polyimide are quite different from polyolefins, highlighting the higher processing temperature and lower flexibility of polyimides. In the proposed invention, the thermal conductivity reaches values around 0.6 W/mK and, in this patent, the values are around 0.2 W/mK, that is, three times lower.

Document WO2015103525 deals with methods for producing boron nitride with higher aspect ratio and productivity. Different boron nitrides and combinations of these with different organic and inorganic fillers are used. When placed in polymer matrices, it is used different polymers (polycarbonates) from those employed in the proposed invention, which are polyolefins. Also in this patent, there are used chemical compounds, such as oils and fibers, which are not included in the proposed invention.

Document WO2012114309 deals with a thermally conductive polymer composite, which achieves this property through the incorporation of thermally conductive fillers. It differs from the proposed invention as it does not consider the crosslinking of the polymer used, which modifies the chemical composition and the necessary processing in addition to the applications due to the best mechanical properties. It also differs in the concentrations and types of fillers used. In the patent, three types of conductive fillers with high concentrations (about 35% by volume, whereas in the proposed invention this concentration is no more than 10% by volume) are used. In the proposed invention, two fillers are used, and in lower concentrations, which reduces the cost and facilitates the processing. Although the patent achieves higher thermal conductivity values (1.0 W/mK versus 0.567 W/mK), processability and flexibility are probably hindered, thus preventing certain applications, such as cable insulation, for example. The volume resistance level is also lower than that of the proposed invention (10⁷ Ohm·cm in the patent versus 10¹⁶ Ohm·cm in the proposed invention).

Document WO2007076014 discloses a material for thermal management that contains a polymeric layer with electrically insulating and thermally conductivity properties. It differs from the proposed invention by the types of polymers used, which are not are crosslinked polyolefins as in the proposed invention. In this patent, the authors use polyimides and thermoset resins as a polymer matrix, which modifies the resulting properties and required processing. The proposed invention has a improved processability and, therefore, greater feasibility for industrial scale production.

Document US2007096083 discloses a conductive polymer nanocomposite that is produced by mixing a suspension of carbon nanotubes and another suspension of conductive polymer particles. This nanocomposite differs from the proposed invention in the types of processing used (the invention does not use suspension or solvent mixing) and in the types of polymers considered (the patent does not cover polyolefins). Both the solvent-free processing and the use of polyolefins instead of thermoset resins (epoxy) make the proposed invention more attractive for industrial scale production on an.

Document JP2005150362 is based on liquid solvent processing, and the proposed invention produces polymer nanocomposites by melt mixing. The polymers used as matrix also are different, and crosslinked polyolefins are not used in the patent. Both the use of solvent-free processing and the use of polyolefins instead of thermoset resins (acrylics) make the proposed invention more attractive for industrial scale production.

In view of the above and, considering the increasing miniaturization of devices with increasing needs for electric power transmission, there is a technological bottleneck in the greater generation and concentration of heat in the components composing these devices, which can cause a drop in efficiency in the transmission of energy or catastrophic structural failures, such as the rupture of the insulating layer itself.

In this way, the present invention arises as an alternative solution to other polymer insulating materials already available, whether they are used as insulating layers on circuit boards, semiconductors, transistors, capacitors, batteries, among other electro-electronic devices, or as insulatings for electrical wires and cables of any size, since polymer nanocomposites obtained by the present invention can reduce the problem of heat accumulation generated by the Joule effect during the transmission of electric power, which limits the performance and can lead to insulation failure.

### SUMMARY OF THE INVENTION

The polymer nanocomposite comprises:
at least one polymer matrix;
at least one inorganic filler;
at least one carbonaceous filler; and
at least one additive.

The polymer matrix is composed of polyolefins, low density polyethylenes (LDPE), linear low density polyethylenes (LLDPE), high density polyethylenes (HDPE), ultra high molecular weight polyethylenes (UHMWPE), ethylene-propylene copolymers, ethylene-propylene rubbers (EPR), ethylene-propylene-diene monomer (EPDM) copolymers, ethylene-octene copolymers, ethylene thermoplastic rubbers at a concentration between 95% and 85% by mass.

The inorganic filler is composed of aluminum oxide (Al₂O₃), aluminum nitride (AlN), boron nitride (BN), hexagonal boron nitride (h-BN), silicon nitride (Si₃N₄), beryllium oxide (BeC) or silicon carbide (SiC), at a concentration between 13.5% and 1.9% by mass.

The carbonaceous filler is composed of graphite, carbon black, carbon nanotubes (CNT), graphene, graphene oxide, and/or reduced graphene oxide at a concentration between 0.1% and 1.5% by mass.

The additive is composed of a crosslinking agent and antioxidant agent.

The crosslinking agent is organic peroxide comprising benzoyl peroxide, tert-butyl cumyl peroxide, 1,4-Bis-(t-butylperoxide-isopropyl)benzene, dicumyl peroxide and dichlorobenzoyl peroxide, at a concentration between 0.1% and 3.0% by mass.

Boron nitride and/or hexagonal boron nitride comes from a hydroxylation process.

Boron nitride and/or hexagonal boron nitride comes from the graphitization of coupling agents on the hydroxyls of boron nitride.

The nanocomposites are used in electrical and electronic equipment with properties for electrical insulation applications and thermal conductivity gain.

Nanocomposite production process comprises the steps of:
a) drying inorganic fillers for 2 to 8 hours at a temperature ranging from 70 to 120° C.;
b) incorporating additives (fillers, crosslinking agent, antioxidants) into olefin-based polymers through melt processing using extruders, injectors, open mixers, closed mixers and/or roller mills, at a processing temperature between 80 and 200° C.;
c) granulating, grinding or pelletizing the material resulting from step “b)”;
d) drying the granulated material for 2 to 24 hours at a temperature ranging from 50 to 80° C.; and
e) crosslinking the material at a temperature of 130 to 200° C. for a period of 1 to 30 minutes.

The nanocomposite material, right after step “d”, is reprocessed.

The nanocomposite is used in the manufacture of electrical and electronic equipment with properties suitable for applications such as electrical insulation and with thermal conductivity gain.

Said equipment includes, but is not limited to, insulating layers on circuit boards, semiconductors, transistors, capacitors, batteries, among other electro-electronic devices, or as insulating for electrical wires and cables.

### Objectives of the Invention

The object of the present invention is to provide a polymer nanocomposite that is electrically insulating and, at the same time, provides better heat dissipation. The benefits of using an electrical insulating material with high thermal conductivity are:
The increased reliability of miniaturized electronic devices, which will be able to operate at higher temperatures without loss of efficiency or failures.
The possibility of greater electric power transmission capacity, since the insulation dissipates the greater amount of heat generated.
Depending on the application, the better thermal management provided by this new material can influence the thickness of the insulating layer, and a reduced layer can be used thus reducing the logistical costs resulting from the reduction of mass and volume of the device as a whole.

### BRIEF DESCRIPTION OF THE FIGURES

FIG. 1—Infrared spectra of BN, BNOH (hydroxylated BN) and 10% BNOH (silanized with 10% by weight APTES) fillers.

FIG. 2—Microscopy performed on the surfaces of samples (1) NXBN 0, (b) NXBN 0.5 and (c) NXBN 1.5. Red arrows indicate the presence of carbon nanotube clusters.

FIG. 3—Example of standard samples for electrical resistivity testing. (a) NXBN 0, (b) NXBN 0.5, (c) NXBN 1.5.

FIG. 4—Interior of the electrification unit, on the left, electrode and guard ring, and, on the right, movable counter electrode and filler.

FIG. 5—Thermal conductivity of the NXBN samples and the CX0 sample for comparison.

### DETAILED DESCRIPTION OF THE INVENTION

The proposed invention reveals the production of polymer nanocomposites for use in electrical and electronic equipment with properties suitable for applications such as electrical insulation and with thermal conductivity gain. The nanocomposite comprises at least one polymer matrix; at least one inorganic filler; at least one carbonaceous filler; and at least one additive.

The content below reveals the elaboration of the nanocomposite, as well as embodiments of the invention to be applied. Such embodiments should not be considered as limiting the invention.

The nanocomposites of the invention have polyolefin-based polymers as a matrix, wherein it is possible to use low density polyethylenes (LDPE), linear low density polyethylenes (LLDPE), high density polyethylenes (HDPE), ultra high molecular weight polyethylenes (UHMWPE), ethylene-propylene copolymers, ethylene-propylene rubbers (EPR), ethylene-propylene-diene monomer (EPDM) copolymers, ethylene-octene copolymers, ethylene thermoplastic rubbers, among others. As an example, polyethylene was used at a concentration between 85% and 95% by mass, preferably between 88.0% and 93.0% by mass.

The inorganic fillers used are one or a combination of thermally conductive and electrically insulative ceramic fillers and one or a combination of carbonaceous fillers, which are also thermally conductive, but electrically conductive. The ceramic fillers are chosen from aluminum oxide (Al₂O₃), aluminum nitride (AlN), boron nitride (BN), silicon nitride (Si₃N₄), beryllium oxide (BeO) or silicon carbide (SiC). hexagonal boron nitride (1 μm) was used an example at a concentration between 1.9% and 13.5% by mass, preferably between 3.0% and 8.0% by mass.

The carbonaceous fillers are chosen from graphite, carbon black, carbon nanotubes (CNT), graphene or graphene oxide. The multi-walled carbon nanotube (MWCNT—diameter ˜5-60 nm and length ˜5-30 μm) with a concentration between 0.1% and 1.5% by mass, preferably between 0.3% and 0.8% by mass. The concentration of nanotubes is small to form a thermal percolated network lacking a percolated network with electric power transmission.

The additives used are a crosslinking agent and an antioxidant. The crosslinking agent is an organic peroxide, which serves to promote the polymer crosslinking. An organic peroxide is chosen from benzoyl peroxide, dicumyl peroxide and dichlorobenzoyl peroxide. Dicumyl peroxide was used as an example at a concentration between 0.1% and 3.0% by mass, preferably between 0.5% and 2.0% by mass. The antioxidant is used to provide better thermochemical stability to the material during processing and shelf life. The antioxidant pentaerythritol tetrakis (3-(3,5-di-tert-butyl-4-hydroxyphenyl) propionate (Irganox 1010) was used at a concentration between 0.1% and 1.5%, preferably between 0.3% to 0.8% by mass.

Two complementary and optional treatments can be used on boron nitride particles to improve the dispersion state and the interfacial adhesion of these fillers to the matrix. These treatments improve the result, but are not essential, and without them the improvement of thermal conductivity also occurs, although to a lesser extent. The first treatment is called hydroxylation, which aims to insert hydroxyl groups onto the surface of h-BN. Depending on the process, the synthesis of boron nitride already provides the presence of some hydroxyls in its structure, however, still in small amounts for an effective silanization. The second treatment is the graphitization of coupling agents on the hydroxyls of boron nitride, which can reduce the interfacial tension between the inorganic filler and the organic polymer matrix.

For the hydroxylation process, a sodium hydroxide solution (NaOH) 5 mol/L is prepared by mixing 400 mL of deionized water and 80 g of NaOH in a 1000 mL volumetric flask. Porcelain pieces are added to the solution, so that the boiling temperature reaches higher levels with the use of a heating blanket up to 120° C. About 10.0 g of boron nitride is added to the mixture. Then, a simple distillation system is used, containing a heating blanket and a condensation column for cooling. Steam cooling can be carried out by means of a water circulator (20° C.). The solution is kept at boiling point for 24 hours. After hydroxylation, the solution has to be washed and filtered. A kitazato-type flask is used, which is coupled to a vacuum filtration assembly and a glass filter. Deionized water is used to wash and lower the concentration of the highly alkaline solution. The material is washed and filtered and dried in a vacuum oven at 80° C. for 24 hours, in order to remove the remaining solvents and obtain the hydroxylated powder. After drying, grinding is carried out with a pestle and mortar to de-agglomerate the powder obtained, which is stored in a desiccator.

Hydroxylized BN (BNOH) can be functionalized using the silane agents (3-aminopropyl)-triethoxysilane (APTES), Vinyltrimethoxysilane (VTMS) or trimethoxy(propyl)silane. As an example, the silane APTES was chosen, at a concentration between 1.0% and 20.0% by weight the amount of boron nitride, preferably from 5.0% to 15.0%. In this procedure, the volume of APTES is removed with a metered syringe, which is transferred to a beaker containing 160 mL of absolute ethyl alcohol and 40 mL of deionized water. The solution is left under mechanical stirring at 80° C. for homogenization, and then 5 grams of filler (BNOH—hydroxylized boron nitride) is added. The mixture is then kept under these conditions for 12 hours. The washing, filtering and drying processes are the same as described for the hydroxylation process.

For the preparation of nanocomposites, melt mixing equipment should be used, allowing the dispersion of the fillers in the polymer matrix. Extruders, injectors, open mixers, closed mixers and/or roller mills can be used. The preparation steps are described below:
a) total drying of inorganic fillers in an incubator, oven or similar, preferably under vacuum, for 2 to 8 hours at a temperature ranging from 70 to 120° C.;
b) incorporating additives (fillers, crosslinking agent, antioxidants) into olefin-based polymers through melting process using extruders, injectors, open mixers, closed mixers and/or roller mills. The processing temperature should be between 80 and 200° C., preferably between 100° C. and 150° C.,
c) performing granulation, grinding or pelletization of the material after processing with the use of grinding equipment, granulators or mills. This step will depend on the type of processing used to incorporate the additives. The final dimension of the granulated material shall be consistent with the subsequent processing to be carried out;
d) total drying of the granulated material in an incubator, oven or similar, preferably under vacuum, for 2 to 24 hours at a temperature ranging from 50 to 80° C.;
e) nanocomposite material produced can be reprocessed to achieve the required shape for the application. With the granulated material, extrusions, co-extrusions, injection molding, compression molding, among other processes can be carried out to give the desired final shape to the product;
f) the crosslinking of the material into its final shape should be carried out together or after the molding process, depending on the type of product and crosslinking agent used. To this end, it must be applied at a certain temperature long enough for the agent to decompose and form crosslinks. In the case of dicumyl peroxide, for example, the most commonly half-lives used are 1 minute at 180° C. and 10 minutes at 140° C.

In order to obtain the results provided, nanocomposites were prepared by melt mixing in a HAAKE torque rheometer with a volumetric capacity of 69 cm³, filling factor of 0.7 and roller rotors. The rotation speed of the rotors was 50 rpm, the processing temperature was 130° C. and the mixing process took place for 7 minutes. The polymer feeding was carried out right at the beginning, by adding boron nitride and the carbon nanotubes after melting. Afterwards, the antioxidant and the organic peroxide were added, and the mixing process was carried out until the end of the 7 minutes scheduled. After the mixing process, the composites were compression molded and crosslinked (formation of crosslinks) in a hydraulic press, at a pressure of 150 kgf/mm², a temperature of 180° C. for 10 minutes. Differential scanning calorimetry tests were carried out to prove the total use of the organic peroxides during chemical crosslinking process.

The volume and surface electrical resistivity measurements were performed according to ASTM D257-14. The specimens for this test have a squared shape with a surface area of 25 cm² and known average thickness greater than 0.5 mm. For the test, the samples were previously cleaned with alcohol in order to minimize possible interferences during the measurement of surface electrical resistivity. The parameters set in the equipment were a voltage of 500 Volts and electrification for 60 seconds, in a network with a frequency of 60 Hz. Before carrying out such measurements, the standard calibration of the equipment was performed. The set of electrodes used consists of a circular electrode, a guard ring and a movable counter electrode where a 10 kg load is applied to perform the test. The results demonstrate that the volume and surface resistivities were maintained in the composite at 0.5% carbon nanotubes in the same order of magnitude of the composite without carbon nanotubes. The value of average volume electrical resistivity after testing 5 specimens was 6.0×10¹⁶ Ω·cm, and the average surface electrical resistivity was 2.16×10¹⁶ Ω·cm. This result demonstrates that the polymer nanocomposite obtained is an electrical insulating, and could be used as an insulating in equipment, devices, accessories, conductors, semiconductors, electrical and electronics, in general.

Thermal conductivity testings were performed using the modified transient plane source (MTPS) method. This method employs a reflectance heat sensor that momentarily applies heat to the sample, allowing the analysis to be performed on a flat surface only. After applying heat, the sensor monitors the temperature variation at the interface and thus determines the thermal conductivity and diffusivity. Square specimens with 3 mm thickness were used and the testing was performed in triplicate. Analyzing the thermal conductivity data, an improvement was observed upon the addition of 0.5% by mass of carbon nanotubes (thermal conductivity=0.573 W/mK), whereby the conductivity value was increased by about 30% in relation to the compound without fillers (thermal conductivity=0.441 W/mK). It is important to emphasize that this increase was caused by the synergy between the carbon nanotube and the boron nitride, since the sample without carbon nanotube and with BN showed a lower performance than the compound without fillers. This result demonstrates the improvement of the thermal management of this electrically insulating polymer nanocomposite, having a higher thermal conductivity to dissipate the heat generated in equipment, devices and electrical and electronic accessories in general.

Another embodiment was also prepared with low density polyethylene nanocomposites with dicumyl peroxide and antioxidant Irganox 1010. Hydroxylated and silanized boron nitride with 10% APTES (10% BNOH) were also added at fixed concentrations. To observe the improvement of heat conduction, multi-walled carbon nanotubes (MWCNT—diameter ˜5-60 nm and length ˜5-30 μm), supplied by the Center for Technology in Nanomaterials and Graphene (CTNano) of the Federal University of Minas Gerais (UFMG), were also used at differing concentrations. The formulations of polymer nanocomposites prepared are shown in Table 1.

TABLE 1
Formulation of polymer nanocomposites obtained by the
embodiment of the present invention.

| | | Concentration (% by mass) | | |
|---|---|---|---|---|
| | | NXB | NXBN | NXBN |
| Ingredient | CX0 | N0 | 0.5 | 1.5 |
| LD5000A | 98 | 93 | 92.5 | 91.5 |
| Carbon nanotubes | 0 | 0 | 0.5 | 1.5 |
| BNOH (10% APTES) | 0 | 5 | 5 | 5 |
| Dicumyl peroxide | 1.5 | 1.5 | 1.5 | 1.5 |
| Irganox 1010 | 0.5 | 0.5 | 0.5 | 0.5 |
| Total | 100 | 100 | 100 | 100 |

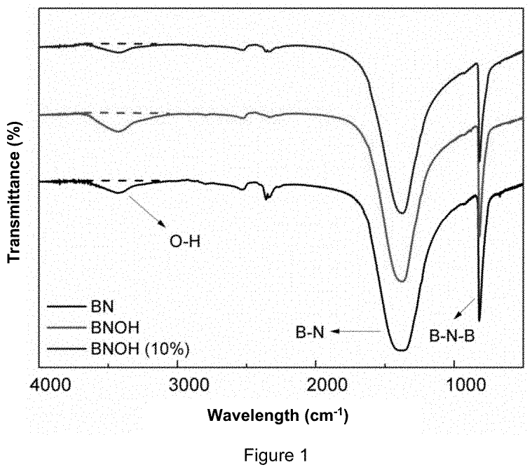

After the hydroxylation and silanization processes, Fourier Transform Infrared Spectroscopy (FTIR) tests were carried out on the inorganic particles, in order to observe the chemical groups related to the silane agent. This test was performed in a spectrophotometer. The spectra were obtained from 32 repetitions, readings from 4000 to 400 cm⁻¹, and resolution equal to 4 cm⁻¹, as shown in FIG. 1. The polymer nanocomposites prepared were heat solubilized in a solvent suitable for each material, and then films were prepared for analysis. The band referring to the —OH group (3419 cm⁻¹) showed perceptible variations consistent with the processes, evidencing the occurrence of silanization. In the spectrum of pure BN filler, this band is already present, given the introduction of hydroxyls in the thermal process of obtaining this filler. During the hydroxylation treatment (BNOH), there is an increase of this band, indicating the insertion of new hydroxyl groups on the surface of the fillers. Finally, due to silanization (BNOH 10%), this band is reduced, which shows the graphitization of the silane agent on the hydroxyls involved.

The polymer nanocomposites from Table 1 were prepared by melt mixing in a HAAKE torque rheometer with small chamber (69 cm³) and roller rotors. The rotation speed of the rotors was 50 rpm, the test temperature was 130° C. and mixing was carried out for 7 minutes. After preparation, the composites were compression molded and crosslinked in a hydraulic press, at a pressure of 150 kgf/mm², a temperature of 180° C. for 10 minutes.

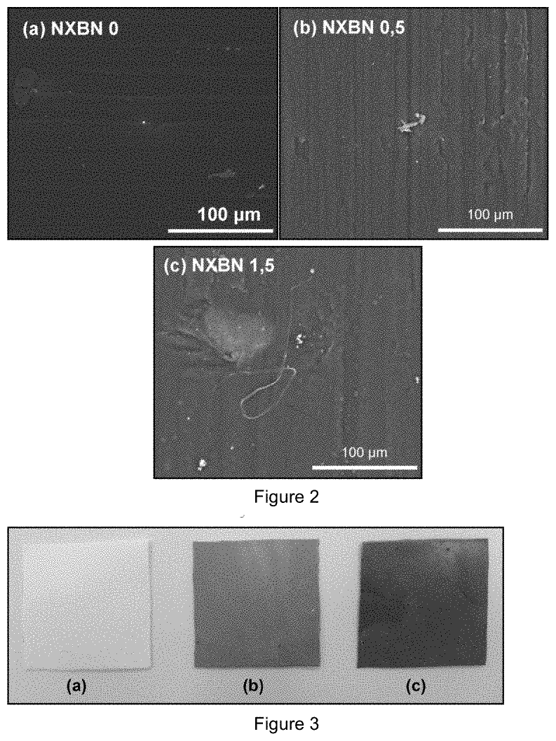

Scanning electron microscopy (SEM) analyzes were performed on the crosslinked samples, with gold metallization of the surface. FEI—Quanta 400 equipment was used with a 20 kV beam in LFD (Large Field Detector) mode. This analysis intended to verify the presence and dispersion of fillers, mainly carbon nanotubes. Using the microscopy shown in FIG. 2, it was possible to observe the absence of carbon nanotubes in the sample NXBN 0 and the increasing presence of this filler from the sample NXBN 0.5 to the sample NXBN 1.5. In the latter, several agglomerates of carbon nanotubes are observed, which can influence the properties of the nanocomposites.

Electrical resistivity measurements were performed in accordance with ASTM D257-14. The polymer nanocomposites for this test are squares with an area of 25 cm², according to FIG. 3, of known average thickness, which were previously cleaned with alcohol in order to minimize possible interferences during the measurement of surface electrical resistivity.

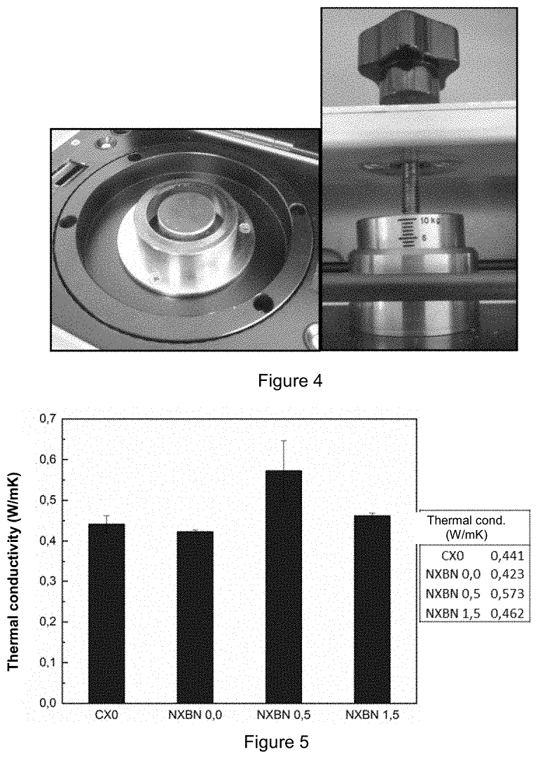

The parameters set in the equipment were a voltage of 500 Volts and electrification for 60 seconds, in a network with a frequency of 60 Hz. Before carrying out such measurements, the standard calibration of the equipment was performed. The set of electrodes used consists of a circular electrode and a guard ring as shown in FIG. 4, and a movable counter electrode where a 10 kg load is applied to perform the test.

The results demonstrate that resistivities were maintained in the same order of magnitude for most samples, according to Table 2. Only the sample NXBN 1.5 showed a drop of one order of magnitude in surface resistivity and lower volume resistivity. It can be seen that, at the concentration of 0.5% by mass of carbon nanotube, there was no modification in the electrical properties, while at 1.5% by mass, the resistivity begins to decrease due to the high electrical conductivity of these fillers. Despite the reduction of the resistivity values, they still remained high, which is desired for the continuity of the electrical insulating character of the material.

TABLE 2
Volume and surface resistivities of polymer nanocomposites
obtained by the embodiment of the present invention.

| | | Average | Volume | Surface |
|---|---|---|---|---|
| Polymer | | Thickness | Resistivity | Resistivity |
| Nanocomposites | | (mm) | (Q · cm) | (Q/cm²) |
| NXBN 0 | 1 | 0.949 | 5.7E+16 | 2.5E+16 |
| | 2 | 0.925 | 4.1E+16 | 1.5E+16 |
| | 3 | 0.929 | 2.3E+16 | 2.0E+16 |
| | 4 | 0.954 | 1.0E+16 | 7.1E+15 |
| | 5 | 1.162 | 1.8E+16 | 1.8E+16 |
| | Average | | 3.0E+16 | 1.7E+16 |
| NXBN 0.5 | 1 | 0.732 | 1.1E+17 | 5.7E+16 |
| | 2 | 1.019 | 6.1E+16 | 5.4E+16 |
| | 3 | 0.960 | 2.1E+16 | 1.4E+14 |
| | 4 | 0.973 | 6.6E+16 | 2.2E+14 |
| | 5 | 0.994 | 4.4E+16 | 1.9E+16 |
| | Average | | 6.0E+16 | 2.6E+16 |
| NXBN 1.5 | 1 | 0.819 | 9.4E+15 | 5.4E+15 |
| | 2 | 1.022 | 3.6E+16 | 2.1E+15 |
| | 3 | 0.966 | 8.8E+15 | 3.9E+14 |
| | 4 | 0.743 | 4.8E+16 | 1.4E+15 |
| | 5 | 0.805 | 6.5E+15 | 7.2E+15 |

| | | |
|---|---|---|
| Average | 2.2E+16 | 3.3E+15 |

Thermal conductivity tests were performed on TCi equipment, and the results are shown in FIG. 5. Squared samples with 3 mm thickness were used and the test was performed in triplicate.

In analyzing the thermal conductivity data, it can be observed that there was an improvement upon the addition of 0.5% by mass of carbon nanotubes, with the conductivity value being increased by about 30% in relation to the composite without fillers (CX0). It is important to emphasize that this increase was caused by the nanotubes and not by the silanized BN, since the sample NXBN 0.0, which lacks nanotubes, had a lower performance than the reference composite. It can also be seen from the results that the increase in the concentration of nanotubes from 0.5% to 1.5% reduced the thermal conductivity, demonstrating that there is a limit to the synergistic formation of the double percolated network (BN and nanotubes).

In view of the content explained above, the present invention of a polymer nanocomposite, as described, has a technical effect of increasing heat transmission without impairing the electrical insulation properties, by increasing the thermal conductivity.

1. Polymer nanocomposite characterized in that it comprises:
at least one polymer matrix;
at least one inorganic filler;
at least one carbonaceous filler; and
at least one additive.

2. Polymer nanocomposite, according to claim 1, characterized in that it comprises, as polymer matrix, the polyolefins, low density polyethylenes (LDPE), linear low density polyethylenes (LLDPE), high density polyethylenes (HDPE), ultra high molecular weight polyethylenes (UHMWPE), ethylene-propylene copolymers, ethylene-propylene rubbers (EPR), ethylene-propylene-diene monomer (EPDM) copolymers, ethylene-octene copolymers, ethylene thermoplastic rubbers at a concentration between 95% and 85% by mass.

3. Polymer nanocomposite, according to claim 1, characterized in that the inorganic filler comprises aluminum oxide (Al₂O₃), aluminum nitride (AlN), boron nitride (BN), hexagonal boron nitride (h-BN), silicon nitride (Si₃N₄), beryllium oxide (BeC) or silicon carbide (SiC), at a concentration between 13.5% and 1.9% by mass.

4. Polymer nanocomposite, according to claim 1, characterized in that the carbonaceous filler comprises graphite, carbon black, carbon nanotubes (CNT), graphene, graphene oxide, and/or reduced graphene oxide at a concentration between 0.1% and 1.5% by mass.

5. Polymer nanocomposite, according to claim 1, characterized in that the additive comprises crosslinking agent and antioxidant agent.

6. Polymer nanocomposite, according to claims 1 and 5, characterized in that the crosslinking agent is organic peroxide, comprising benzoyl peroxide, tert-butyl cumyl peroxide, 1,4-Bis-(t-butylperoxide-isopropyl)benzene, dicumyl peroxide and dichlorobenzoyl peroxide, at a concentration between 0.1% and 3.0% by mass.

7. Polymer nanocomposite, according to claims 1 and 6, characterized in that the antioxidant agent is pentaerythritol tetrakis (3-(3,5-di-tert-butyl-4-hydroxyphenyl) propionate at a concentration between 0.1% and 1.5% by mass.

8. Polymer nanocomposite, according to claims 1 and 3, characterized in that the boron nitride and/or hexagonal boron nitride comes from a hydroxylation process.

9. Polymer nanocomposite, according to claims 1 and 3, characterized in that the boron nitride and/or hexagonal boron nitride comes from the graphitization of coupling agents on the hydroxyls of boron nitride.

10. Polymer nanocomposite, according to claims 1 to 9, characterized in that it is used in electrical and electronic equipment with properties for electrical insulation applications, and thermal conductivity gain.

11. Process of obtaining a polymer nanocomposite, according to claim 1, characterized in that it comprises the steps of:
a) drying inorganic fillers for 2 to 8 hours at a temperature ranging from 70 to 120° C.;
b) incorporating additives (fillers, crosslinking agent, antioxidants) into olefin-based polymers through melt processing using extruders, injectors, open mixers, closed mixers and/or roller mills, at a processing temperature between 80 and 200° C.;
c) granulating, grinding or pelletizing the material resulting from step “b)”;
d) drying the granulated material for 2 to 24 hours at a temperature ranging from 50 to 80° C.; and
e) crosslinking the material at a temperature of 130 to 200° C. for a period of 1 to 30 minutes.

12. Process of obtaining a polymer nanocomposite, according to claim 11, characterized in that the nanocomposite material, right after step “d”, is reprocessed.

13. Use of polymer nanocomposites, as defined in any one of claims 1 to 10, characterized in that it is used in the manufacture of electrical and electronic equipment with properties suitable for applications such as electrical insulation and with thermal conductivity gain.

14. Use, according to claim 13, characterized in that said equipment comprises, but not limited to: insulating layers on circuit boards, semiconductors, transistors, capacitors, batteries, among other electro-electronic devices, or as insulating for electrical wires and cables.
